(19) United States
(12) Patent Application Publication
(10) Pub. No.: US 2004/0163107 A1
(43) Pub. Date: Aug. 19, 2004

(54) Television advertising system and method

(76) Inventor: Douglas Crystal, Chagrin Falls, OH (US)

Correspondence Address: Warren A. Sklar, Renner, Otto, Boisselle & Sklar, LLP, 19th Floor, 1621 Euclid Avenue, Cleveland, OH, 44115-2191, US

(21) Appl. No.: 10/367,517

(22) Filed: Feb. 13, 2003

(51) Int. Cl. H04N 7/025; G06F 3/00; H04N 7/10; G06F 13/00; H04N 5/445; H04N 7/173

(52) U.S. Cl. 725/32; 725/34; 725/35; 725/42; 725/110; 725/112

(57) ABSTRACT

A method of doing business and a system wherein broadcast programming is provided, the programming being primarily classified advertisements, and an automated online method and system and a semi-automated method and system for preparing, building, placing and scheduling classified advertisements to sell, lease, rent and/or use goods and services. The classified advertisements may be broadcast by television, internet or other network, or telephone.

### TECHNICAL FIELD

The present invention relates generally, as indicated, to a television advertising system and method and, more particularly, to television advertising and a system that are directed primarily to classified advertising, and the like.

### BACKGROUND

For many years the average person has been selling personal items and services by word of mouth (person to person advertising), newspapers and magazines (for example, classified advertisements), and other print media (specific advertisements that may be mailed, posted on a bulletin board, etc.). Personal items and services in the modern age of the internet are sold via internet advertising through companies that provide for such sale, for example, Ebay and the like. The words item, product, good, and merchandise are used below and are intended to mean the same thing unless otherwise indicated by context.

Advertising a product or service for sale via television broadcasting during a commercial break in a television show is rather expensive, as is well-known. Usually products and services that are advertised via television are branded products or branded services. A branded product or service may be, for example, a particular model automobile, a particular food product, a particular theater or other entertainment program, etc. Usually an average person-would not be able to afford advertising to sell a personal item or service via television advertising.

Another form of television advertising of a branded product is known as the “infomercial”. An infomercial usually has a duration of approximately thirty minutes (or more) of television broadcast time and that time is used to talk about the product or service, to show the product or service, to provide accolades from people who allegedly have used or purchased the product or service, etc.; and part of the time is used to sell the product, providing price information, telephone number/mailing address information, etc. The cost to prepare a conventional infomercial is substantial, and that cost added to the cost for broadcast time is even more substantial; and usually the sum is out of reach of the average person, who may be interested to sell a personal item or service.

Another approach to sell products using television broadcasting techniques is the Home Shopping Network, QVC and other such programs and television channels. However, these also are directed to the sale of branded products. For example, a new paint brush may be shown, demonstrated, advertised, etc., on a given channel, such as QVC; and hundreds or even thousands of units of the particular paint brush may sell to individuals who place an order with the station over a finite time period of, for example, thirty minutes or so while the paint brush is being shown in a broadcast and for a short time afterwards. Such a sales approach, though, is not conducive to the advertising and selling of personal items and services.

Thus, there is a need to provide effective, efficient, and reasonably priced advertising opportunities for the average person to sell personal items and services. There is a similar need for various entities, such as businesses, organizations, and the like to advertise their products and services without encountering the high cost of television advertising, for example, as was described above.

A conventional way of selling personal items and services has been to place a phone call to a newspaper or other print media organization or company and to place a classified advertisement. A person (responder) seeing the advertisement in the newspaper or other print media may respond by contacting the seller or possibly the newspaper to learn additional information and/or to purchase the item or service. In placing the advertisement, a person may say or tell pertinent information concerning the item or service to a clerk, who writes the information and places it for publication in the appropriate classification or category of merchandise or services. If desired, the person placing the classified advertisement may contact the newspaper online to place the classified advertisement. The procedure for making a television commercial or infomercial usually is substantially more complex than the procedure for making and/or placing a classified advertisement in a newspaper and, accordingly, is much more expensive, as was mentioned above.

The Ebay auction house and other similar auction houses are so vast that sometimes it is almost impossible without a great deal of work to find a specific item of interest for purchasing. Similarly, it is difficult to find an appropriate classification for an item of personal merchandise or service that is to be placed for auction on the Ebay auction site, for example. Therefore, as the Ebay auction site increases in size, the ability conveniently to sell merchandise or services is diminished.

### SUMMARY

An aspect of the invention relates to an advertising method, including broadcasting programming primarily directed to classified advertisement.

An aspect of the invention relates to a method of advertising, including providing a broadcasting program primarily directed to classified advertisements, selling time in the broadcasting program for presenting classified advertisements, and broadcasting the classified advertisements.

An aspect of the invention relates to a method of selling products, including placing a classified advertisement in a broadcast program that primarily broadcasts classified advertisements.

An aspect of the invention relates to a method fo doing business, including providing for broadcasting on a broadcast program of primarily classified advertisements a number of classified advertisements, and providing a computer program for preparing a classified advertisement.

An aspect of the invention relates to a method of creating a classified advertisement, including contacting a classified advertising entity, selecting the type of classified advertisement to be created, accessing a scheduler and selecting the number of times for presenting the classified advertisement and the times for presenting the classified advertisement, building the classified advertisement, approving the classified advertisement for presenting, and wherein the foregoing steps are carried out online via a network connection or via a telephone connection.

An aspect of the invention relates to a method of buying a product, including observing a classified advertisement for a product broadcast as part of a broadcasted program that primarily broadcasts classified advertisements, and at least partly in response to observing the classified advertisement purchasing the product.

An aspect of the invention relates to a method of selling a product, including placing a classified advertisement for broadcasting as part of a broadcasted program that primarily broadcasts classified advertisements, and subsequent to receiving a suitable response to the classified advertisement, selling the product to the responder.

An aspect of the invention relates to a method for building a classified advertisement, including connecting online to an advertising provider electronically, and carrying out the following steps while online with the advertising provider, providing a written description of an item to be advertised, providing classification of the item, providing price information, reviewing and approving the advertisement, and, if not approved, repeating one or more of the preceding steps until approved.

An aspect of the invention relates to a method of creating a classified advertisement, including carrying out the following steps online: providing billing information, choose classified advertisement type, choose a pricing package, schedule broadcast duration and time, and build the classified advertisement.

An aspect of the invention relates to a method of interactively watching television, including viewing a television program, and changing the view to a classified advertising program that provides broadcast programming primarily directed to classified advertisements.

To the accomplishment of the foregoing and related ends, the invention comprises the features hereinafter fully described and particularly pointed out in the claims. The following description and the annexed drawings set forth in detail certain illustrative embodiments of the invention. These embodiments, however, are merely indicative of a few of the various ways in which the principles of the invention may be employed. Other objects, advantages and novel features of the invention will become apparent from the following detailed description of the invention when considered in conjunction with the drawings.

Although the invention is shown and described with respect to one or more preferred embodiments, it is obvious that equivalents and modifications will occur to others skilled in the art upon the reading and understanding of the specification. The present invention includes all such equivalents and modifications, and is limited only by the scope of the claims.

### BRIEF DESCRIPTION OF THE DRAWINGS

In the annexed drawings:

FIG. 1 is a schematic block diagram illustrating a system and a method in accordance with an embodiment of the invention;

FIG. 2 is a schematic illustration of a system for creating advertising and for broadcasting advertising;

FIG. 3 is a schematic block diagram representing a method in the form of a flow chart or logic diagram depicting a method of creating an advertisement for broadcasting;

FIG. 4 is a schematic block diagram that is in greater detail than that of FIG. 3 and represents a method in the form of a flow chart or logic diagram depicting a number of steps and procedures carried out in accordance with an embodiment of the present invention for creating an advertisement for broadcasting; and

FIG. 5 is a schematic block diagram of a method representing an example of using the present invention.

### DESCRIPTION

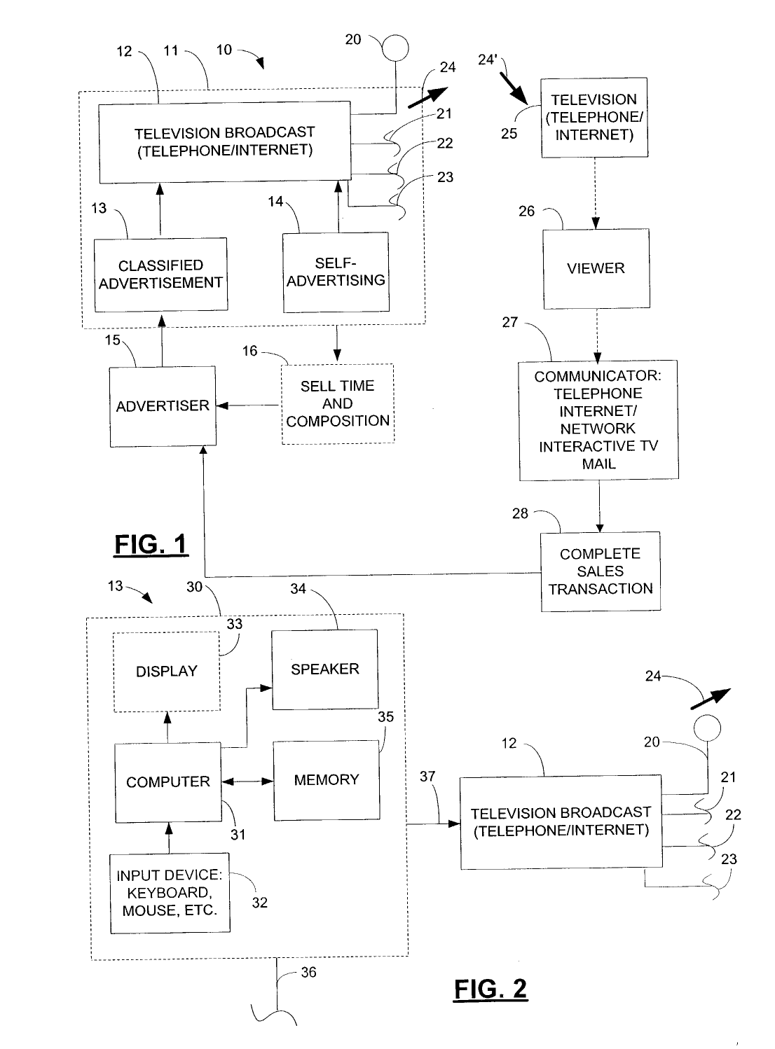

Referring in detail to the drawings, wherein like reference numerals designate like parts in the several figures, and initially to FIG. 1, a block diagram of a television advertising system and method in accordance with an exemplary embodiment of the present invention is illustrated at 10. The system 10 includes a number of parts that may be cooperative in carrying out a method in accordance with the present invention.

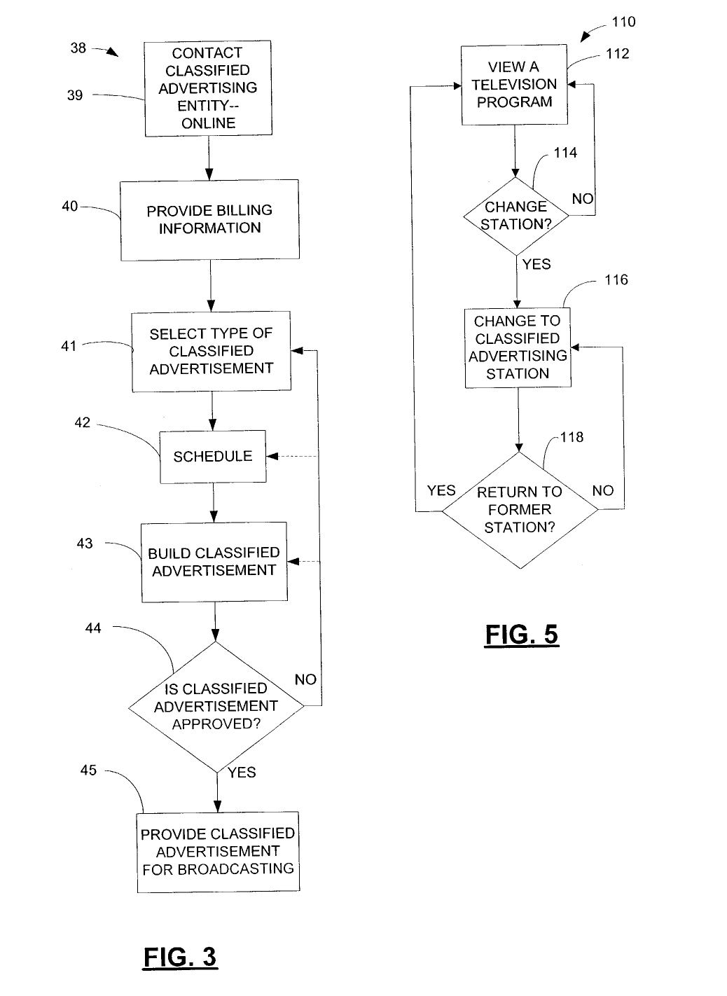

In use the system 10 provides for broadcast television programing that is primarily classified advertising. In FIGS. 1 and 2 an embodiment of the system is illustrated and the methods associated with the system are described below; and in FIGS. 3-5 embodiments of methods in accordance with the invention are illustrated. The invention is described below with respect to FIGS. 1-5 in connection with television broadcasting of programing directed primarily to classified advertisements and the like. However, as is described further below, features of the invention also may be used in connection with broadcasting information and interacting, e.g., advertising, selling, and purchasing, over a network, such as the internet, for example, and also via telephone communication and/or other communication that provides advertising information to a potential purchaser and also may allow the potential purchaser to effect purchasing of merchandise, services or the like. Further, as is described further below, the invention allows for the combining of advertising and purchasing modalities, such as television broadcasting, interactive television, whereby a viewer can control not only viewing but also communication functions, such as those needed in purchasing an advertised product or service; network; and/or telecommunications, e.g., telephone, etc.

An aspect of the invention is a method of doing business. The method and portions of the method are described in greater detail below and are pointed out in the claims. An aspect of the method includes broadcasting such that primarily the broadcasting is of classified advertisements. The broadcasting may be via television, network, e.g., the internet, telephone or other broadcasting. The method of doing business also includes methods relating to preparing, building, and placing classified advertisements and to methods of watching and of responding to classified advertisements. In FIG. 1 the system 10 is illustrated as an example of a system for carrying out an embodiment of the present invention. In this regard, the system 10 includes a broadcaster 11 that provides television broadcasting of classified advertising, as is represented at block 12. The classified advertising is an assemblage of classified advertisements 13. The assemblage of classified advertisements may be provided by respective advertisers and/or may be prepared by the broadcaster 11 or by another entity or a combination of the foregoing.

As used herein, the term classified advertisement refers to an advertisement for merchandise, sometimes referred to as goods, products, items, etc., and for services. Such merchandise and services usually may be assigned to a classification, category, grouping, or the like, examples of which may be used bicycles, kitchen sink products (such as a used sink), a floor waxing service, etc.

The broadcaster 11 also may provide a television broadcast of self-advertising shown at block 14 in FIG. 1. Self-advertising is promotional material encouraging people to advertise on, view, purchase from, etc., and otherwise to utilize the services offered by the broadcaster 11.

Associated with the broadcaster 11 is an advertiser 15. The advertiser 15 may be a person, a business entity, an organization, etc. The advertiser provides the broadcaster 11 information indicating merchandise or service that is to be advertised in one of the classified advertisements 13. The advertiser 15 may create its own classified advertisement or it may furnish information to the broadcaster 11, which alone or jointly with the advertiser 15 creates a classified advertisement for broadcasting. At block 16 a step of selling time and composition is illustrated. For example, a broadcaster 11 may sell broadcast time to an advertiser 15 for presenting advertisements in a broadcasted program and also may sell to the advertiser 15 a service of composing one or more classified advertisements 13 for the advertiser. The selling of time may be to non-business persons who want to sell products or services, either personal items, such as their own personal property, e.g., a used bicycle, used automobile, etc. or their own service, e.g., carped cleaning, window washing, etc., or the selling of time may be to business persons who want to sell products or services, such as those offered for sale by the business person's business.

As was described just above, the broadcaster may be directly involved with the various portions or steps carried out in practicing the invention, for example, selling advertising time and composition services 16 to the advertiser 15, assembling classified advertisements 13, and broadcasting the classified advertisements by television broadcast 12. The broadcaster 11 also may include in broadcast programing self-advertising 14. It will be appreciated, though, that the various steps or portions of the process described here may be carried out by more than the broadcaster. For example, a salesperson may sell advertising time and/or composition services 16. The advertiser 15 may prepare its own classified advertisement or a portion of that classified advertisement. The classified advertisements 13 may be prepared by a separate entity from the advertiser 15 and from the broadcaster 11, for example, by an advertising company. The self-advertising 14 also may be prepared by the broadcaster 11 or by a different entity, e.g., an advertising company. The function of providing the television broadcast 12 may be carried out by a separate television station that is licensed under the Federal Communications Commission (FCC), by some other television broadcasting company, by a separate entity that rents or leases time for television broadcasting purposes, etc. In the illustrated embodiment of FIG. 1 the various functions and steps represented at 12, 13, 14 and 16 are shown as being carried out by the broadcaster 11, except for the steps or functions of the advertiser shown at 15—the advertiser is the customer who wants to sell a product, service or the like.

The television broadcast 12 in the system 10 is provided by various methods, four of which are illustrated schematically in FIG. 1. One approach is to provide a television broadcast via conventional television broadcasting using an antenna 20 that sends appropriate signals to a remote antenna for use by a television or may send signals to another transmitting device, such as a sub-station, a satellite in space, etc., that provides a signal to a receiving television. Another approach is to use cable transmission represented at 21, such as, for example, cable television, fiber optic cable, electrical cable, etc. Another approach is to provide the signals via telephone line or other suitable telecommunication connection, which is represented at 22 in FIG. 1. A further approach is to provide broadcasting via a network, e.g., the internet, as is represented at 23 in FIG. 1; such broadcasting may be by direct broadcasting as by advertisements distributed directly to a number of users who connect to the internet, by providing the classified advertisements and/or access to them via a web page, etc.

The television broadcast signals 24, and received signals 24, are received and displayed by television 25 to a viewer 26, such as a person viewing his or her television 25. The viewer 26 may watch any of a variety of television programing on the television 25. However, the viewer 26 may select for viewing on the television 25 the classified advertisements provided by the broadcaster 11. Having available a television program dedicated primarily to classified advertisements allows the viewer 26 to view a wide variety of advertisements. Moreover, with on-demand selection capability, the viewer may select not only the classified advertisement programing channel but also specific classifications of classified advertisements for viewing. The viewer 26 may view the classified advertisements over an extended period or may switch to the classified advertisements channel from time to time, for example, during a lull in the programing on another channel, such as, for example, a portion in a movie that is not of interest, a time out during a sports game, a commercial/or station break in a program, etc.

The viewer 26 may find that a classified advertisement presents a product or service of interest and may desire to purchase that product or service. Thus, the viewer may be considered a responder who responds to the classified advertisements. The viewer (responder) 26 then accesses a communicator 27 to communicate with the advertiser 15 to consummate the purchase, as is represented at 28. Such communicator and sales completion functions may be carried out via telephone, via the internet or some other network connection, via interactive television connection back through the broadcaster 11, for example, via regular mail service, etc. The purchase can be made directly from the advertiser 15 or from or via the broadcaster 11 or some third party sales agent or sales agency.

From the foregoing, then, it will be appreciated that the invention is directed to a television advertising system and method in which television broadcasting primarily is classified advertisements. The classified advertisements are prepared, and they are broadcast. The broadcast information is received and displayed on a television 25 and can be viewed by a viewer 26, who may respond to a given classified advertisement using a communicator 27 to complete a purchase transaction 28, for example. The invention initially is described in detail herein with respect to television broadcasting and viewing classified advertisements by television. However, as will be described further below, the invention also includes the possibility of broadcasting classified advertisements and/or transmitting information pertaining to classified advertisements by a telephone, internet or some other network, etc., and receiving the classified advertisements via the appropriate receiver, such as, for example, telephone, computer, some other connection to a network, e.g., cell phone, etc.

In FIG. 2 is illustrated a computer system 30 used by or in the broadcaster 11 (FIG. 1) to provide the classified advertisements 13 for television broadcast 12. The computer system 30 includes a computer 31, such as a conventional personal computer or other computer with suitable processing capability or access as a terminal to suitable processing capability. The computer system 30 also includes an input device 32 for the computer 31. The input device may be a keyboard, mouse, joystick, video input device, digital camera, scanner, microphone, etc. A display 33 coupled to the computer 31 allows an advertiser 15 or other entity that is working to prepare, to broadcast, etc. the advertisement (FIG. 1) to view a classified advertisement and to see various programing and other functions being carried out on the computer 31 to create classified advertisements. A speaker 34 may be coupled to the computer 31 to provide audio output representing the audio component of a classified advertisement. A memory 35 provides usual memory functions for the computer 31 to carry out its processing functions in the course of creating, preparing, etc. classified advertisements and includes suitable computer programs for carrying out the various portions of the methods described herein; and the memory 35 also may include capability of storing classified advertisements for subsequent broadcast. The memory may be a hard drive, random access memory, compact disk (CD), digital video disk (DVD), tape or virtually any other memory device or medium. An input 36 to the computer system 30 may be provided from an advertiser 15 (FIG. 1) or from some other source that provides information concerning a classified advertisement that is to be prepared using the computer system 30 for television broadcast. An output 37 from the computer system is coupled to the television broadcast system 12 providing content for such television broadcast purposed.

In accordance with the present invention, an advertising method provides for broadcasting of programing primarily directed to classified advertisements. The broadcasting may be via radio waves/signals, network, satellite, internet, telephone, cable television, etc. The classified advertisements may be directed to advertising for sale, rent, lease, use, etc., goods and/or services. Exemplary goods may be a new or used bicycle, a used automobile, etc., and exemplary services may be those offered by a musical band, bar, tavern, restaurant, house cleaning services, movie, concert, obituaries, boats, clothing, jewelry, furniture, etc.; the classified advertisements may be directed to virtually any type of classified advertisement typically found in a printed newspaper or other media. Still other examples of goods and services that may be offered Although the broadcasting is directed primarily to classified advertisements, the broadcaster also may include self-advertising, such as, for example, advertising the services offered by the broadcaster.

The classified advertisements may be directed to services offered by a restaurant, lounge, etc., and also may be directed to goods, such as the sale of compact disks (CDs) or the like. Each classified advertisement is provided over a relatively short duration in the typical case and is presented as part of a sequence of a number of classified advertisements that are broadcast. An exemplary classified advertisement may take from a few seconds (say from 10 to 45 seconds) to, for example, one minute or more. The broadcasting provides the classified advertisements continuously or substantially continuously.

The classified advertisements may include a mini-infomercial. A conventional infomercial is very expensive to prepare and usually is broadcast over a time period on the order of about one half hour or more. A mini-infomercial may be directed to providing information similar to that in a conventional infomercial, but the time period over which it is broadcast is substantially shorter, for example, on the order of seconds or a few minutes, rather than over the long time period of conventional infomercials.

Turning to FIG. 3, an automated method for constructing and placing a classified advertisement is illustrated in the form of a flow chart 38. The method 38 allows an advertiser 15, for example, to build a classified advertisement independently while online by network connection using a computer, the internet, and/or other means to couple with the broadcaster 11 or other entity that is used to prepare a classified advertisement for broadcasting. The method 38 may be considered in a sense as an order entry system allowing an order for a classified advertisement to be taken and the classified advertisement to be constructed or prepared for being broadcast. The method also allows the advertiser to place the classified advertisement for broadcasting, e.g., by the broadcaster 11.

At block 39 the advertiser 15 or some other entity that desires to build a classified advertisement contacts the classified advertising entity, such as the broadcaster 11 or some other entity that is used to prepare the classified advertisements. Contact can be made using a computer, an internet connection, the internet, one or more servers, etc. Contact can be made using radio signal transmission by a satellite, radio towers, etc., or using telephone connection, optical cable connection, or by virtually any means available now or in the future.

At block 40 the advertiser provides billing information to the advertising entity. The billing information may include identification of the advertiser, billing address, credit card number, etc. as may be typical of online sales and/or business transactions. The actual billing may be charged directly to a credit card or to a credit account set up with the advertising entity, charged directly to a bank account, etc. The actual amount charged would depend on the type of classified advertisement, scheduling, such as how many times the classified advertisement is broadcast, the duration of the broadcast, what time frame is selected for broadcasting, e.g., prime time, afternoon, late night, etc.

At block 41 the advertiser would select the type of classified advertisement that would be billed and broadcast. Several types of classified advertisements, as examples, include job openings, used items, such as bicycles, television, cars, furniture, etc., restaurant services, musical band services, and virtually any other type of classified advertisement currently shown in printed media, such as a newspaper, magazine, flier, etc., and others that may develop in the future. Another type of classified advertisement may be “personals” that are used to help people meet each other, for example. The type of classified advertisement also may indicate whether the advertisement is exclusively words (verbiage) or may also include music, still pictures, moving pictures (video), etc.

At block 42 a schedule for broadcasting the classified advertisement is selected or is composed. For example, the schedule may be provided as a package, whereby for a given fee a classified advertisement for a specified duration would be broadcast a prescribed number of times at specified time periods, such as prime time, afternoon, late night, etc. Scheduling also could be based on availability of time slots to broadcast the classified advertisement. Scheduling also could be based on specified times and durations that the advertiser 15 desires for broadcasting of the classified advertisement. Various scheduling software packages are commercially available and, if desired, can be tailored to specific requirements of a user of the invention. Also, the writing of new computer program software to carry out the various scheduling functions just described could be carried out in a reasonable period of time by a person who has ordinary skill in the art of writing computer software. Furthermore, scheduling could be done by an advertiser 15 filling in a form online to indicate the desired scheduling times, durations, etc., and that information could be provided to an individual who would manually identify which classified advertisements would be broadcast at which times. Scheduling may be based on the particular advertising package purchased by the advertiser 15, e.g., the advertiser purchases one minute of time and is able to use it to present an advertisement at four different times for 15 seconds each, etc.

At block 43 the advertiser builds the classified advertisement. Building the classified advertisement may include a number of steps. For example, the text (verbiage) to be included in the classified advertisement would be prepared and furnished. If the classified advertisement is to be shown only as words on a screen, then no sound would be necessary. However, in many instances it would be desired to have the words read orally or by electronic equipment. Reading of the words may be carried out by the advertiser 15, by a professional reader or actor, by electrical voice generating equipment that generates speech sounds in response to word data that is provided electronically, etc. Building the classified advertisement also may include inserting still pictures, moving pictures, such as video images, and/or music to the classified advertisement.

At block 44 an inquiry is made whether the classified advertisement is approved. Approval may include several steps, one of which is review and approval by the advertiser 15. If the classified advertisement is not approved by the advertiser, then the steps 41, 42 and/or 43 could be repeated to re-do the information or procedures effected there to lead to a classified advertisement that is approved by the advertiser. Approval also could be by the advertising entity, such as the broadcaster, for example, to confirm or to verify that the classified advertisement is suitable in subject matter and quality, for example, for broadcasting via television or if desired, via cable, internet connection, telephone, etc. If the classified advertisement is not approved by such advertising entity, then the steps 41, 42 and/or 43 could be repeated until approval is obtained.

At block 45 the classified advertisement is provided for broadcasting. For example, the classified advertisement may provide as one of the classified advertisements 13 for television broadcast 12 at the broadcaster 11.

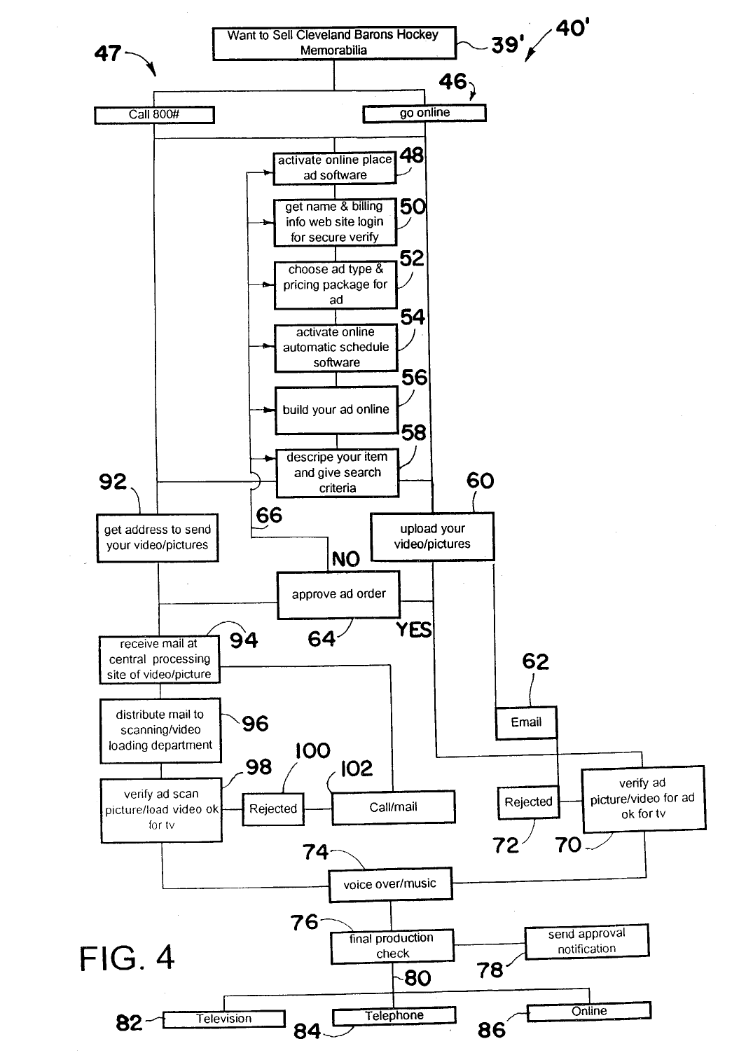

Turning to FIG. 4, a method for creating and placing a classified advertisement according to an embodiment of the invention is illustrated schematically in a flow chart or procedure guide 40′. The method 40′ illustrated in FIG. 4 is an expanded example of the method 40 illustrated and described above with respect to FIG. 3. Two different tracks 46, 47 are included in the flow chart 40′. Track 46 provides for creating and placing a classified advertisement via an online connection, such as via the internet; track 47 represents steps followed to create and to place a classified advertisement via a telephone call. Both tracks 46 and 47 include a number of similar steps that are shown connected to both such tracks.

The online track 46 is described here. At block 39′ a seller (also referred to as advertiser) 15 desires to sell an item, such as, for example, hockey memorabilia, by contacting an advertising entity, such as the broadcaster 11, and placing a classified advertisement for broadcast by the broadcaster 11. The advertiser 15 goes online at block 46, for example, by using a computer to connect via the internet to the broadcaster 11, e.g., to block 13 (FIG. 1) via a connection 36 (FIG. 2). The connection allows the advertiser 15 to activate computer program software to place a classified advertisement at block 48. Such software represented and initiated at block 48, sometimes referred to as automated production process software, carries out a number of steps, which are described just below at blocks 50-58.

At block 50 the name of the advertiser 15 and billing information, such as credit card number, billing address, etc., are provided by the advertiser 15 to the broadcaster 11, for example, by filling out an appropriate form and transmitting it to the broadcaster. This step may include certain security features to protect the credit card number and/or other secure information.

At block 52 the advertiser 15 chooses a classified advertisement type and a pricing package for the classified advertisement. The type may be, for example, a word advertisement, a video or picture type of advertisement, a very short duration advertisement, a mini-infomercial type advertisement, etc. The type also may include a designation of a particular category or classification for the classified advertisement, such as, for example, automobiles, bicycles, books, restaurant services, etc. The pricing package may be any of various pricing packages that are provided by the broadcaster 11. An exemplary pricing package may include options for the number of times the classified advertisement would be broadcast, the time slots, time periods or time frames, e.g., prime time, afternoon, late night, etc. time slots, and other aspects, such as whether the classified advertisement would be prepared primarily by the advertiser 15 or would be prepared in part or even entirely by the broadcaster 11. For example, a platinum pricing package may provide for broadcasting the same classified advertisement a prescribed number of times in prime time with some additional broadcasting in other time frames, whereas gold and silver pricing packages may provide for fewer broadcasts, respectively, in prime time and/or may only provide for broadcasting in time frames other than prime time, etc. At block 52 special packages for particular classifications of classified advertisements may be provided. Also, special packages for encouraging placing the classified advertisement for broadcasting a specified number of times or in specified time slots (periods) may be offered to the advertiser 15.

At block 54 online automatic scheduling software is activated. Such scheduling software may be conventionally available software that is used in the broadcasting industry to schedule programs, commercials and the like. The scheduling software allows the advertiser 15 to select the duration of the classified advertisement, the number of times the classified advertisement would be broadcast, and the time periods in which the classified advertisement would be broadcast, such as, for example, prime time, afternoon time, late night, etc.; such scheduling would be based on the type of pricing package selected in block 52 that would limit the available time periods, number of times the advertisement is broadcast, duration of the advertisement, and so forth. At block 54 the scheduling software may provide multiple options of which television time slots will be used for broadcasting the classified advertisement and which classified advertisements would be provided via the internet and/or via telephone inquiry. Scheduling could be done manually. Also, if desired, a commercially available scheduling software may be used, or may be modified for particular functions. Also, to meet desired scheduling functions a computer program could be written.

At block 56 steps are taken to build the classified advertisement online. At this point the advertiser 15 may provide the verbiage for the classified advertisement to describe the item or service being advertised (this may be provided in written, oral, electronic or some other form), price information, order information, etc. Also, music may be included in the classified advertisement as it is built at block 56. The music may be background music to emphasize or to highlight features of the classified advertisement and the item being advertised or the music may be representative of the item being sold, such as, for example, a compact disk with various music on it. (If track 47 were followed, whereby a classified advertisement is placed and built via phone call, the phone call from the advertiser may come to a call center, for example, in which case music and/or pictures, video, etc. may be added later in the building or production process.)

At block 58 the item or service being offered for sale in the classified advertisement is described in words prepared by the advertiser 15. The advertiser also would provide search criteria, such as, for example, classification information to facilitate locating the advertisement in a group of advertisements for similar items or services when using on demand television, when searching via internet or telephone, or when the broadcaster 11 desires to group classified advertisements of a particular classification type to draw the attention of viewers and purchasers interested in that classification of items or services. The search criteria is analogous to metatags used for internet searching. For example, at block 56 the advertising copy is presented for a collection of baseball cards of a given team from a given year; and at block 58 search criteria naming key players in the collection and other information about the collection could be provided.

At block 60 the advertiser 15 can upload video images or digital pictures, etc. for inclusion in the advertisement. The upload can be made directly while on line with the broadcaster 11, e.g., via connection 36, for example. Alternatively, the upload can be provided via email connection representing at 62, whereby the advertiser 15 would email to the broadcaster 11 the video or digital pictures, etc.

At block 64 the advertiser 15 is able to play back the classified advertisement and to approve it. The approval process may include confirming correctness of all of the information provided in blocks 48-60. If any of that information, format, description, etc., is not approved by the advertiser 15, then the advertiser can return to one or more of the steps at blocks 50-58 as well as to block 60 as is represented by the flow path 66. Review may be made using the system 13, e.g., the computer 31, display 33 and speaker 34 or by another computer system or by other equivalent reviewing device or system.

If at block 64 the classified advertisement is approved by the advertiser 15, then the advertiser indicates approval and at block 70 the classified advertisement is provided for verification by the broadcaster 11 or such other entity needing to give verification that the language, presentation, pictures, video, and/or subject matter of the classified advertisement are acceptable for broadcasting via television or other medium. If at block 70 the verification is negative because the classified advertisement is rejected for one or more reasons, then such rejection is indicated at block 72, and an email communication is sent via block 62 to the advertiser 15 to indicate the rejection. The advertiser 15 then may make appropriate revisions and resubmit the classified advertisement going through the steps described above, for example or via an abbreviated process that would show the changes made to the classified advertisement subsequent to the rejection to facilitate the verification process at block 70.

After a classified advertisement has been verified as acceptable for broadcasting at block 70, then at block 74 the possibility of providing voice over and/or music to the classified advertisement is offered. The voice over may be provided by a person reading text of the classified advertisement, such as a professional actor reading the material. Alternatively, the text of the classified advertisement may be read by the advertiser 15. Music may be added to the classified advertisement, as may be desired by the advertiser 15 and/or by the broadcaster 11 or other entity that prepares the classified advertisement to enhance the aesthetic character of the classified advertisement and/or for other purposes.

At block 76 a final production check of the classified advertisement is made. For example, the classified advertisement is played for a reviewer, who would confirm the classified advertisement is ready for broadcasting. The reviewer may use the computer 31, display 33 and speaker 34 to play the classified advertisement for review; or another system for displaying the classified advertisement for review. If the classified advertisement is approved, then an approval notification is sent to the broadcaster 11 and to the advertiser 15 at block 78. If there is a problem with the classified advertisement as found during the final production check at block 76, then appropriate steps can be taken, such as, for example, to repeat one or more of the steps following the activation at block 48, the uploading of video or pictures at block 60, revising or redoing the voice over and/or music at block 74, etc.

Also, at block 76 an acceptable final production check approving the classified advertisement allows the classified advertisement to be distributed for broadcasting. Line 80 in the flow chart 40 illustrates distribution of the classified advertisement for broadcasting via television at block 82, via telephone at block 84 and via online network access at block 86. Broadcasting via television at block 82 is carried out following the procedure described above with respect to FIGS. 1 and 2. For example, the classified advertisement is provided at 13 in the system 10. The broadcaster 11 may provide the classified advertisement for television broadcast 12 at the appropriate time(s) and for the appropriate duration(s), as were selected at the pricing package 52 and automatic scheduling 54 blocks that were described above. If on demand television capability is available to the viewer 26 via the television 25, a cable connection or other connection (not shown) etc., such on demand capabilities being available in the art, then the viewer 26 may be able to select a given category or classification of classified advertisements for viewing at a given time, for example, instantly or subsequently.

At block 84 the classified advertisement is made available via telephone. Various possibilities are available for this function. As one example, a viewer 26 (in this case actually a person telephoning the broadcaster 11) may telephone to a service provided by the broadcaster 11 or by some other entity to access classified advertisements. A schedule or “tree” system may be provided by the broadcaster, for example, to allow the viewer to depress certain keys on the telephone to select specific classifications or categories of classified advertisements to be heard/listened to. In response to hearing a classified advertisement of interest such that the user wishes to hear the classified advertisement a second time, the user could press a key to repeat the classified advertisement. The item offered for sale in the classified advertisement may be purchased by the viewer 26 selecting and pressing a telephone key to allow for automated purchasing or to connect with an operator to place an order. Alternatively, the viewer could make a separate telephone call to the advertiser 15 or sales agent to make the desired purchase.

The approved classified advertisement may be provided via line 80 to block 86 for online distribution of the classified advertisement. For example, the classified advertisement may be provided by or at a website of the broadcaster 11. The classified advertisement may be placed in the website, for example, such that it is available for all to view at any time, for all to view only at selected times, for viewing as one of a general collection of classified advertisements without regard to the specific nature of the item or service offered for sale, or categorized or classified according to the nature of the item or service offered for sale. A purchase of the item or service offered for sale in a classified advertisement may be carried out online by a viewer 26 using a connection link provided in the classified advertisement to the broadcaster 11, to the advertiser 15, or to some other service.

Track 47 of the flow chart 40′ method involves the preparing of a classified advertisement via telephone connection to the broadcaster 11, for example. Steps carried out in track 47 are similar to those carried out in track 46 and are described in further detail below.

An advertiser 15 would call via telephone connection to the broadcaster 11 or to such other entity that would be preparing the classified advertisement, as is indicated at block 90. Using keys on the telephone and/or using oral communication with an operator or other person, the advertiser 15 would carry out the steps represented at blocks 48-58 in the flow chart 40 of FIG. 4. After block 58, rather than carrying out the uploading step at block 60, at block 92 video and/or digital pictures or other pictures can be sent to the broadcaster 11, for example, by mail, by email, by internet or by some other means.

At block 64 the advertiser 15 may approve the advertisement. If it is not approved, then one or more of the steps following the activating of the online advertisement software 48-58 may be carried out and/or new video or pictures may be presented to the broadcaster 11 (block 92).

At block 64 if the classified advertisement is approved, then the video or pictures are provided to and at block 94 are received at a central processing site, such as an advertising agency, the broadcaster 11, etc. At block 96 the video, pictures, etc. are scanned and/or are otherwise converted to appropriate format for inclusion in the classified advertisement and are added to the classified advertisement text or verbiage portion.

At block 98 the classified advertisement is checked to verify that it has been prepared properly and can be used for broadcasting in one or more of the manners described above, such as, for example, via television 82, telephone 84, and/or online 86. If the classified advertisement is rejected as not being suitable for broadcasting, e.g., the subject matter is unacceptable, the quality is unacceptable, the presentation is unacceptable, etc., then at block 102 a telephone call is placed to the advertiser 15 and/or mail is sent to the advertiser 15 to indicate such rejection. Such call or mail may also may be provided to the central processing site for the video and/or picture at block 94 to check the character, nature, quality, etc. of the video, picture and/or text of the classified advertisement to try to make corrections so that the classified advertisement would be verified as acceptable for broadcasting.

At block 98, if the classified advertisement is verified as being acceptable for broadcasting, then the flow chart continues to blocks 74-86 to carry out the various steps described above to complete the classified advertisement, to check it, to send approvals, and to broadcast it.

As much of the above function of creating a classified advertisement is done electronically, for example, on-line the various steps may provide information that can be tracked. Such information can be billing information, accounting information and information about respective advertisers to facilitate directing the offering of future services to individual advertisers, such as discounts for further advertising services. Tracking of information, such as the geographic locations of respective advertisers may help in tailoring the services and methods offered by the present invention for such advertisers' advantage. Other information that can be tracked includes the nature of products and services being advertised, time periods when advertisements of particular types are advertised, etc. Some or all of the tracked information may lead to improvements in the services and methods offered by the present invention and commercial benefit to users of the invention.

Briefly referring to FIG. 5, a flow chart 110 represents an example of a method of using the invention or the results of the invention to view a classified advertisement on television or the like to which is broadcast (e.g., via radio signals, electrical cable, optical cable, or any other means) a program, which is directed primarily to classified advertisements or classified advertising. At block 112 a viewer views a television program, for example, a sports event, movie, talk show, etc. At block 114 an inquiry is made, whether to change the station, e.g., to “flip” to another channel. If the viewer is most interested in the current television program, there would be no change. However, if the viewer is bored with the program showing on the current channel or with a commercial break or station break occurring that is not of interest, desires to check out the classified advertisements on the channel that is broadcasting classified advertisements, or knows that a particular type of classified advertisements are being broadcast, e.g., used motorcycles, the viewer may change the channel to the classified advertising television station at block 116. At block 118 an inquiry is made whether to return to the former (or to another) station from the classified advertising station. For example, if the classified advertisements of interest have passed (already been shown) or the commercial break on the prior channel probably has ended, then the viewer may switch channels back to the original channel or to a different channel. Alternatively, the viewer could continue viewing the classified advertising station.

Although the invention has been shown and described with respect to a certain embodiment or embodiments, equivalent alterations and modifications will occur to others skilled in the art upon reading and understanding this specification and the annexed drawings. In particular regard to the various functions performed by the above described integers (components, assemblies, devices, compositions, etc.), the terms (including a reference to a “means”) used to describe such integers are intended to correspond, unless otherwise indicated, to any integer which performs the specified function of the described integer (i.e., that is functionally equivalent), even though not structurally equivalent to the disclosed structure which performs the function in the illustrated exemplary embodiment or embodiments of the invention. In addition, while a particular feature of the invention may have been described above with respect to only one of several illustrated embodiments, such feature may be combined with one or more other features of the other embodiments, as may be desired and advantageous for any given or particular application.

It will be appreciated that portions of the present invention can be implemented in hardware, software, firmware, or a combination thereof. In the described embodiment(s), a number of the steps or methods may be implemented in software or firmware that is stored in a memory and that is executed by a suitable instruction execution system. If implemented in hardware, for example, as in an alternative embodiment, implementation may be with any or a combination of the following technologies, which are all well known in the art: discrete logic circuit(s) having logic gates for implementing logic functions upon data signals, application specific integrated circuit(s) (ASIC) having appropriate combinational logic gates, programmable gate array(s) (PGA), field programmable gate array(s) (FPGA), etc.

Any process or method descriptions or blocks in flow charts may be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

The logic and/or steps represented in the flow diagrams of the drawings, which, for example, may be considered an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

The above description and accompanying drawings depict the various features of the invention. It will be appreciated that the appropriate computer code could be prepared by a person who has ordinary skill in the art to carry out the various steps and procedures described above and illustrated in the drawings. It also will be appreciated that the various terminals, computers, servers, networks and the like described above may be virtually any type and that the computer code may be prepared to carry out the invention using such apparatus in accordance with the disclosure hereof.

I claim:

1. An advertising method, comprising
broadcasting programming primarily directed to classified advertisement.

2. The method of claim 1, further comprising selling time for presenting classified advertisements in a broadcasted program.

3. The method of claim 2, said selling time comprising selling time to non-business persons to sell products.

4. The method of claim 2, said selling time comprising selling time to business persons to sell products.

5. The method of claim 1, further comprising advertising the service of the broadcasted programming.

6. The method of claim 1, wherein a given classified advertisement is broadcast at least twice, each broadcast being at a different point in time.

7. The method of claim 6, further comprising selling an amount of time to broadcast a given advertisement, and dividing that amount of time into multiple time slots for broadcasting the given advertisement.

8. The method of claim 1, further comprising producing the classified advertisement as at least one of a video, picture, verbiage, music.

9. The method of claim 1, said broadcasting programming comprising broadcasting mini-infomercial.

10. The method of claim 1, said broadcasting programming comprising broadcasting classified advertisements for entertainment services.

11. The method of claim 1, said broadcasting programming comprising broadcasting job-related classified advertisements.

12. The method of claim 1, said broadcasting programming comprising providing on demand selection of classes of goods and services for which advertisements are sought.

13. A method of advertising, comprising
providing a broadcasting program primarily directed to classified advertisements,
selling time in the broadcasting program for presenting classified advertisements, and
broadcasting the classified advertisements.

14. The method of claim 13, said broadcasting of classified advertisements comprising broadcasting classified advertisements for the sale or lease of goods or services.

15. The method of claim 13, further comprising providing an order entry system.

16. The method of claim 13, further comprising providing scheduling.

17. The method of claim 13, further comprising providing a tracking system.

18. The method of claim 13, further comprising providing an accounting system.

19. A method of selling products, comprising
placing a classified advertisement in a broadcast program that primarily broadcasts classified advertisements.

20. The method of claim 19, further comprising completing a sales transaction for a responder to the classified advertisement.

21. The method of claim 20, wherein the responder is a person who responds to the classified advertisement via a network connection.

22. The method of claim 19, wherein said placing a classified advertisement comprises placing a classified advertisement for at least one of a good, a service, and information about a person.

23. The method of claim 19, further comprising presenting the broadcast program via a website.

24. The method of claim 19, further comprising presenting the broadcast program via television broadcast.

25. The method of claim 19, further comprising producing classified advertisements for sale of at least one of a house, chair, vehicle, boat, airplane, jewelry, clothing, functions, antiques, obituaries, personals.

26. The method of claim 19, further comprising receiving information by at least one of telephone, network, internet, and mail to place a classified advertisement.

27. A method of doing business, comprising
providing for broadcasting on a broadcast program of primarily classified advertisements a number of classified advertisements, and
providing a computer program for preparing a classified advertisement.

28. The method of claim 27, further comprising providing scheduling of time for broadcasting the classified advertisements.

29. The method of claim 28, said providing scheduling comprising using computer software to schedule the number of times for broadcasting of a classified advertisement and the periods at which the classified advertisement is to be broadcast.

30. The method of claim 28, wherein said providing scheduling comprises providing access to scheduling computer software via a network or telephone connection.

31. A method of creating a classified advertisement, comprising
contacting a classified advertising entity,
selecting the type of classified advertisement to be created,
accessing a scheduler and selecting the number of times for presenting the classified advertisement and the times for presenting the classified advertisement,
building the classified advertisement,
approving the classified advertisement for presenting, and
wherein the foregoing steps are carried out online via a network connection or via a telephone connection.

32. The method of claim 31, further comprising reviewing the classified advertisement on line prior to approving for presenting.

33. A method of buying a product, comprising
observing a classified advertisement for a product broadcast as part of a broadcasted program that primarily broadcasts classified advertisements, and
at least partly in response to observing the classified advertisement purchasing the product.

34. A method of selling a product, comprising
placing a classified advertisement for broadcasting as part of a broadcasted program that primarily broadcasts classified advertisements, and
subsequent to receiving a suitable response to the classified advertisement, selling the product to the responder.

35. A method for building a classified advertisement, comprising
connecting online to an advertising provider electronically, and carrying out the following steps while online with the advertising provider,
providing a written description of an item to be advertised,
providing classification of the item,
providing price information,
reviewing and approving the advertisement, and, if not approved, repeating one or more of the preceding steps until approved.

36. The method of claim 35, further comprising uploading pictures of the item to the advertising provider.

37. The method of claim 35, further comprising uploading video of the item to the advertising provider.

38. A method of creating a classified advertisement, comprising
carrying out the following steps online:
providing billing information,
choose classified advertisement type,
choose a pricing package,
schedule broadcast duration and time, and
build the classified advertisement.

39. The method of claim 38, further comprising reviewing the classified advertisement, and determining whether the classified advertisement is approved, and if not approved repeating the build step.

40. The method of claim 38, said build step comprising,
providing a description of the subject of the classified advertisement and pricing information.

41. The method of claim 40, further comprising providing at least one of a picture and a video of the subject of the classified advertisement.

42. The method of claim 40, further comprising providing classification information for the subject of the classified advertisement.

43. A method of interactively watching television, comprising
viewing a television program, and
changing the view to a classified advertising program that provides broadcast programming primarily directed to classified advertisements.

44. The method of claim 43, further comprising using an on-demand selecting process to select for viewing classified advertisements of a desired classification.
